(19) United States
(12) Patent Application Publication
(10) Pub. No.: US 2012/0222117 A1
(43) Pub. Date: Aug. 30, 2012

(54) METHOD AND SYSTEM FOR PREVENTING TRANSMISSION OF MALICIOUS CONTENTS

(75) Inventors: Onn Chee Wong, Singapore (SG); Shi Jie Ding, Beijing (CN); Jun Liang Daryl Woo, Singapore (SG)

(73) Assignee: INFOTECT SECURITY PTE LTD, Singapore (SG)

(21) Appl. No.: 13/393,754

(22) PCT Filed: Sep. 2, 2009
(86) PCT No.: PCT/SG09/00311

§ 371 Date: May 18, 2012

(51) Int. Cl. G06F 21/22

(52) U.S. Cl. 726/23

(57) ABSTRACT

A method and a system for preventing transmission of malicious contents are provided. The method includes intercepting at a network gateway device of a server network a digital communication being sent from the server network to an external network; searching the digital communication for a malicious transmission schema that can be used to cause a malicious transmission on a recipient of the digital communication; and taking an action to hinder the transmission of malicious contents if a malicious transmission schema is found.

### TECHNICAL FIELD

Embodiments relate generally to a method and a system for preventing transmission of malicious contents.

### BACKGROUND

Malware (an abbreviation for malicious software) is designed to infiltrate or damage a computer system without the owner's consent. Past statistics suggest that the release rate of malicious code and other unwanted programs may be exceeding that of legitimate software applications. Past statistics also suggest that the amount of malware produced in 2007 was as much as the total amount produced over the previous 20 years.

The most common pathway for malware to infiltrate or damage a computer system is through the Internet, for example by e-mail or the World Wide Web. Current existing anti-malware solutions are mainly client side applications that prevent malware execution by recognizing malware signatures or behaviors. One shortcoming of such solutions is that the anti-malware programs need to be installed on every single computer that is connected to the Internet, and require frequent updates of their malware databases.

Another type of anti-malware solution involves studying abnormal network traffic patterns resulting from malware, and taking preventive measures according to such traffic patterns. However, such solutions require lengthy and laborious attempts to understand how each piece of malware affects the network traffic patterns. Such measures are corrective in nature but do not prevent malware execution.

Therefore, there is a need to provide a new method and system which overcomes at least one of the above-mentioned problems.

### SUMMARY

In an embodiment, there is provided a method for preventing transmission of malicious contents. The method includes intercepting at a network gateway device of a server network a digital communication being sent from the server network to an external network; searching the digital communication for a malicious transmission schema that can be used to cause a malicious transmission on a recipient of the digital communication; and taking an action to hinder the transmission of malicious contents if a malicious transmission schema is found.

In another embodiment, there is provided a system for preventing transmission of malicious contents. The system includes a network gateway device of a server network that intercepts a digital communication being sent from the server network to an external network, the network gateway device including a network connection to the server network and the external network; and a processor configured to search the digital communication for a malicious transmission schema that can be used to cause a malicious transmission on a recipient of the digital communication; and take an action to hinder the transmission of malicious contents if a malicious transmission schema is found.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the various embodiments. In the following description, various embodiments are described with reference to the following drawings, in which:

FIG. 1 shows a flowchart of a process for preventing transmission of malicious contents in accordance with an embodiment.

FIG. 2 shows a schematic diagram of a system for preventing transmission of malicious contents in accordance with an embodiment.

FIGS. 3a and 3b show examples of a cross-site script (XSS).

FIG. 3c shows an example of an invisible iframe.

FIGS. 3d to 3i show examples of obfuscated JavaScript.

FIG. 3j shows an example of a phishing iframe.

FIG. 3k shows an example of external JavaScript.

FIG. 3l shows a schematic diagram illustrating an example of how cross-site request forgery works.

FIG. 3m shows an example of cross-site request forgery.

FIG. 4 shows a flowchart of a process for searching a digital communication for a malicious transmission schema in accordance with an embodiment.

FIG. 5 shows a flowchart of a process for determining if a digital communication includes cross-site script (XSS) in accordance with an embodiment.

FIG. 6 shows a flowchart of a process for determining if a digital communication includes invisible iframes in accordance with an embodiment.

FIG. 7 shows a flowchart of a process for determining if a digital communication includes obfuscated JavaScript in accordance with an embodiment.

FIG. 8 shows a schematic diagram of a computer system.

FIG. 9 shows a schematic diagram of a system having one or more network gateway devices operating in prevention mode in accordance with an embodiment.

FIG. 10 shows a schematic diagram of a system having a network gateway device operating in detection mode in accordance with an embodiment.

### DETAILED DESCRIPTION

Exemplary embodiments of a method and a system for preventing transmission of malicious contents are described in detail below with reference to the accompanying figures. It will be appreciated that the exemplary embodiments described below can be modified in various aspects without changing the essence of the invention.

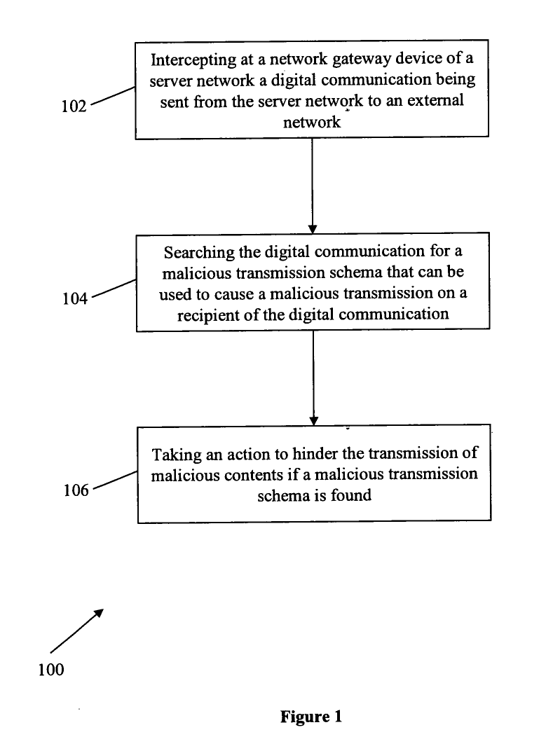

FIG. 1 shows a flowchart 100 of a process for preventing transmission of malicious contents. At 102, a digital communication being sent from a server network to an external network is intercepted at a network gateway device of the server network. The digital communication may include but is not limited to web pages, emails and instant messages. The digital communication may also include messages posted and files shared on forums, blogs and social networking websites. At 104, the digital communication is searched for a malicious transmission schema that can be used to cause a malicious transmission on a recipient of the digital communication. The malicious transmission may be transmitted from a source outside the server network. At 106, an action is taken to hinder the transmission of malicious contents if a malicious transmission schema is found.

By hindering the transmission of malicious contents, the above described process can prevent the malicious transmission schema from causing the downloading of malicious contents from an external source when the malicious transmission schema is received and/or executed by the recipient of the digital communication. That is, as used herein, a malicious transmission schema is not, itself, necessarily malicious code or content. This makes it difficult for anti-virus programs or other software that looks for signatures of malicious code to detect such transmission schemas. Rather, a malicious transmission schema can cause the downloading and/or execution of malicious code when it is received and/or executed by a recipient. For example, a malicious transmission schema might be an invisible link that causes a recipient to inadvertently download and execute malicious code. Another example of a malicious transmission schema might be an automatic link that causes the recipient's computer to make requests of a web site in order to bring down the web site through a high volume of such requests—i.e., a link that causes the recipient to participate (inadvertently) in a denial of service attack. By identifying and hindering such malicious transmission schema on a server-side network, the further spread of malicious contents can be contained. On the other hand, conventional systems that look for malicious contents, for example, by searching for known virus signatures within a transmission are generally unable to prevent malicious transmission schema from downloading malicious contents from an external source. Accordingly, embodiments of the present invention are concerned with finding malicious transmission schema in digital communications at the server side, rather than searching for known malware signatures, typically at the client side, as is done in conventional malware detection systems.

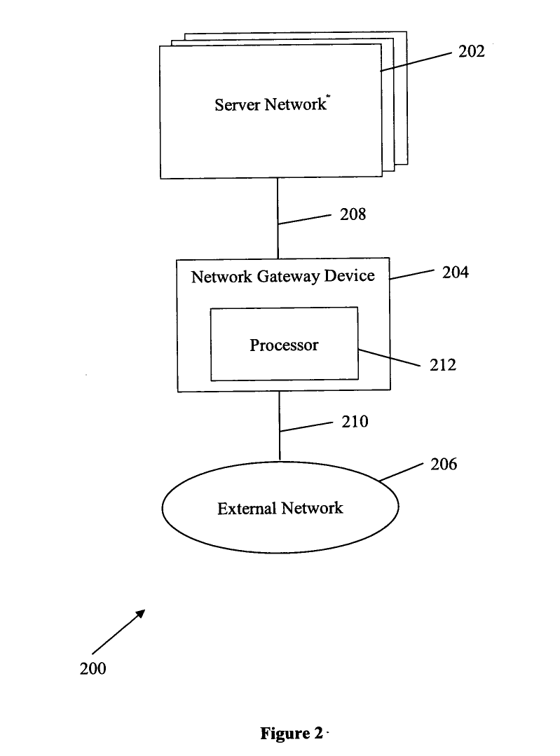

FIG. 2 shows a schematic diagram of a system 200 for preventing transmission of malicious contents. The system 200 may have three components, namely a server network 202, a network gateway device 204 and an external network 206. In different embodiments, the system 200 may comprise different components and the number of components for the system 200 may also vary.

The server network 202 may include one or more web servers. The server network 202 may include the network gateway device 204. The network gateway device 204 may be coupled between the server network 202 and the external network 206. In other words, the network gateway device 204 may have a network connection 208 to the server network 202 and a network connection 210 to the external network 206. The network gateway device 204 of the server network 202 may intercept a digital communication being sent from the server network 202 to the external network 206. The digital communication may include but is not limited to web pages, emails and instant messages. The digital communication may also include messages posted and files shared on forums, blogs and social networking websites.

The external network 206 may include one or more requestor machines. The requestor machines may include but are not limited to computers, laptops, personal digital assistants (PDAs), palmtops, mobile phones, and other mobile or network-connected devices. Users may request web pages from the server network 202 using the requestor machines.

To ensure that the digital communication is safe to be sent to the external network 206 (e.g. the recipient of the digital communication), the network gateway device 204 may have a processor 212 (e.g. malicious code detection module) configured to determine if the digital communication includes a malicious transmission schema that can be used to cause a malicious transmission on the recipient of the digital communication. The malicious transmission may be transmitted from a source outside the server network 202. The malicious transmission schema may be injected into the digital communication in a form including but is not limited to cross-site script (XSS), invisible iframes, obfuscated JavaScript, phishing iframes, external JavaScript and cross-site request forgery.

For example, for cross-site script (XSS), scripts from a remote site may be injected into e.g. web pages by referencing to the remote site. The scripts injected into the web pages may be e.g. a JavaScript or may be embedded in another file type like an image (jpeg file, bitmap file, etc.) or a PDF file. In such cases, the scripts injected into the web pages may be executed by a web browser without being known by an Internet user.

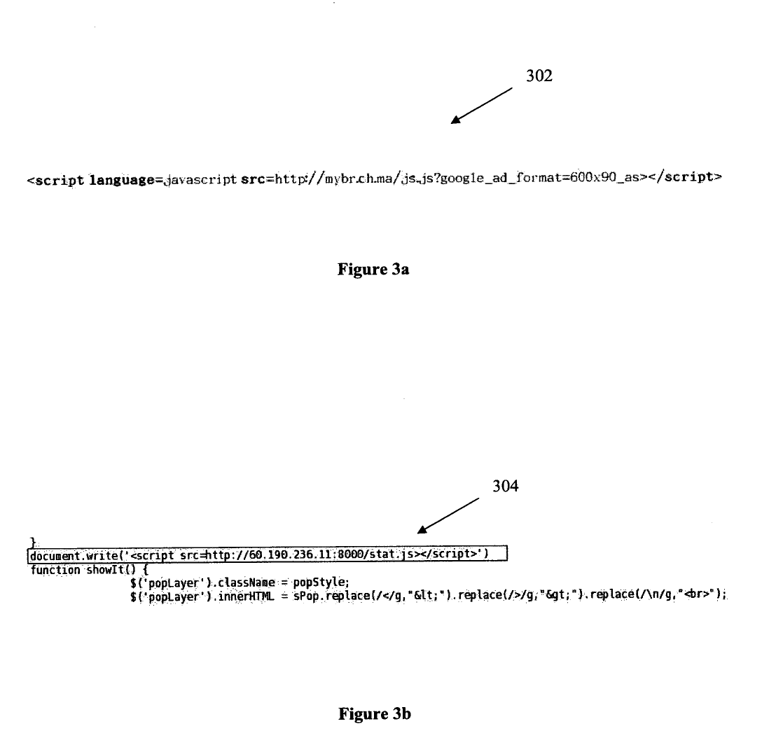

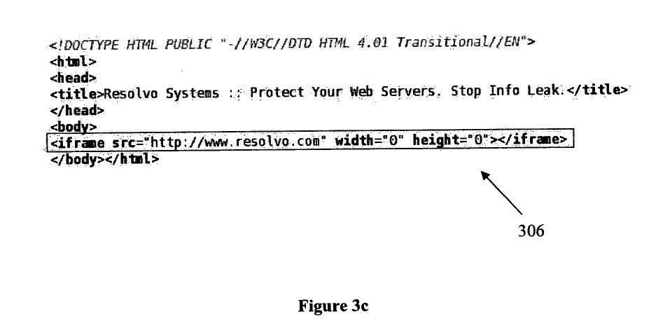

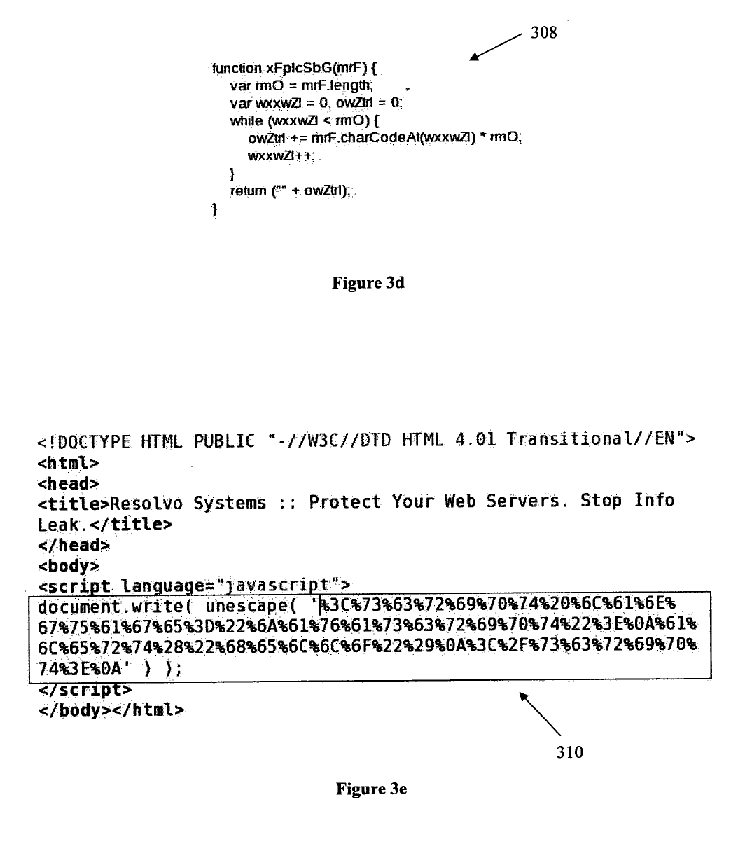

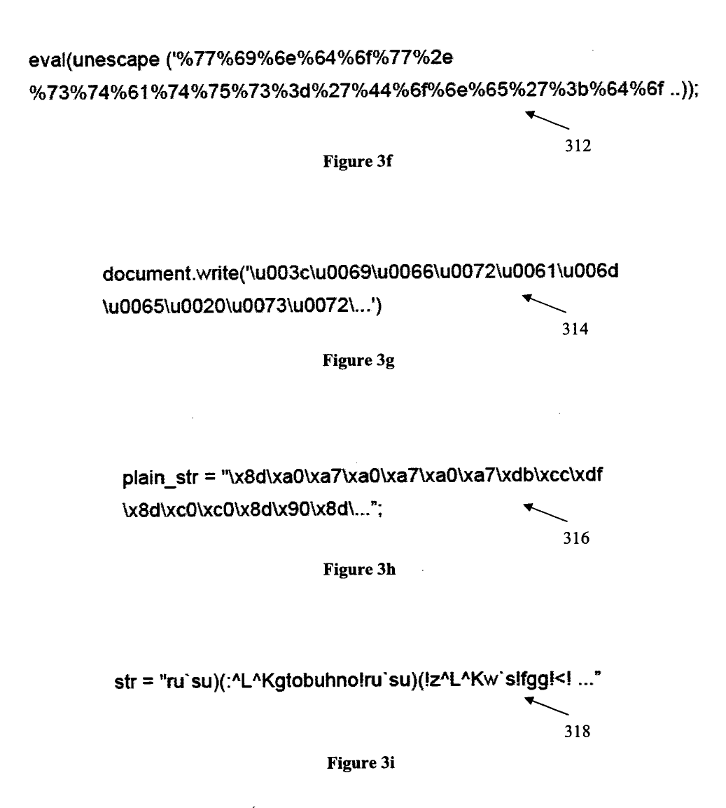

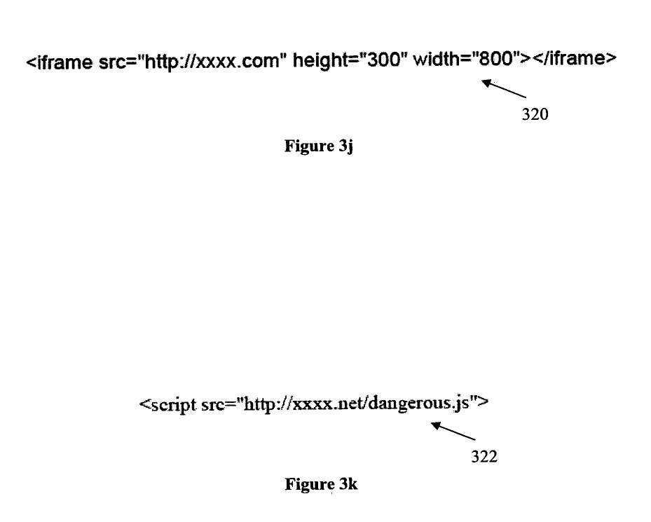

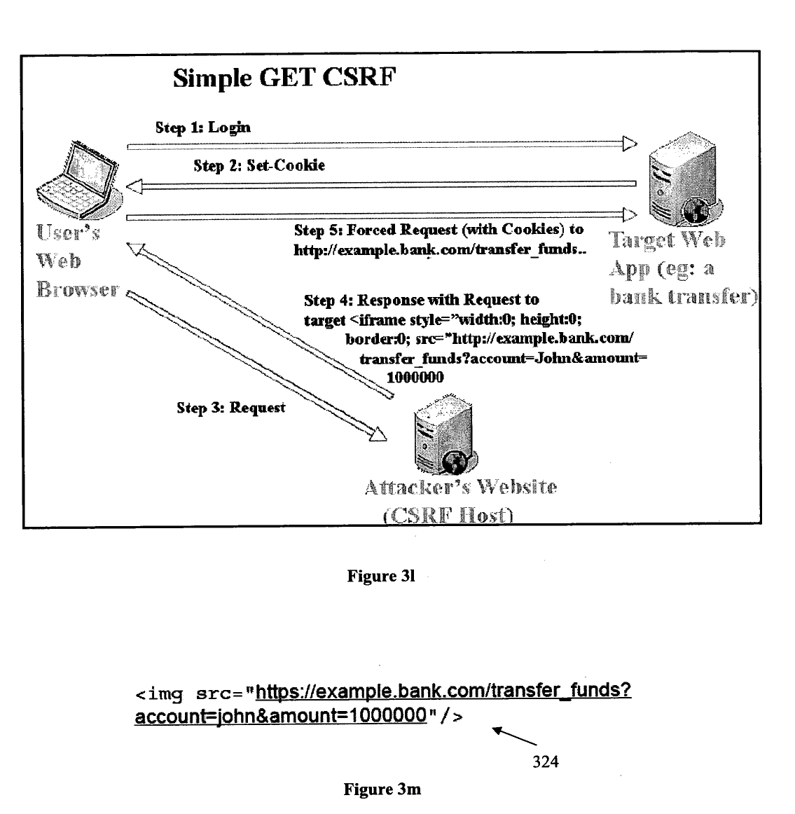

FIG. 3a shows an example of a cross-site script (XSS) 302. The cross-site script (XSS) 302 is a remote JavaScript with a uniform resource locator (URL) “http://mybr.ch.ma/js.is?google_ad_format=600×90 _as” which is injected into a web page.

FIG. 3b shows another example of a cross-site script (XSS) 304. The cross-site script (XSS) 304 is a remote JavaScript having a document.write command of JavaScript.

An invisible iframe is an iframe created with a height and a width so small that it cannot be seen by the recipient of the digital communication. FIG. 3c shows an example of an invisible iframe 306. A width and a height of the iframe 306 are set to zero. Therefore, the scripts are injected into a web page without being visible to e.g. Internet users (i.e. being hidden from Internet users).

Obfuscated JavaScript is JavaScript that has been made difficult to understand, thus concealing its purpose. FIG. 3d shows an example of obfuscated JavaScript 308, where the JavaScript 308 is syntactically correct. FIG. 3e shows another example of obfuscated JavaScript 310. An encoded string of an “unescape” function is a JavaScript 310 that prompts “Hello” on a user screen. FIG. 3f shows another example of obfuscated JavaScript 312. The obfuscated JavaScript codes 312 are escaped ASCII values. FIG. 3g shows another example of obfuscated JavaScript 314. The obfuscated JavaScript codes 314 are escaped Unicode values. FIG. 3h shows another example of obfuscated JavaScript 316. The obfuscated JavaScript codes 316 are XORed with ASCII values. FIG. 3i shows another example of obfuscated JavaScript 318. The JavaScript codes 318 are obfuscated using XOR with character encoding.

A phishing iframe is an iframe created in a legitimate page that actually belongs to another site but looks identical to the legitimate page. Any information entered in the phishing iframe will be sent over to the other site. FIG. 3j shows an example of a phishing iframe 320.

External JavaScript is JavaScript that is hosted on external sites but is downloaded when a user is looking at the current page. FIG. 3k shows an example of a phishing iframe 322.

Cross-site request forgery can force an end user to execute unwanted actions on a web application in which the user is currently authenticated. The unwanted actions may include changing of password or transferring of assets. If the targeted user is the administrator, the entire web application may be compromised. FIG. 3l shows a schematic diagram illustrating an example of how cross-site request forgery works. FIG. 3m shows an example of cross-site request forgery 324.

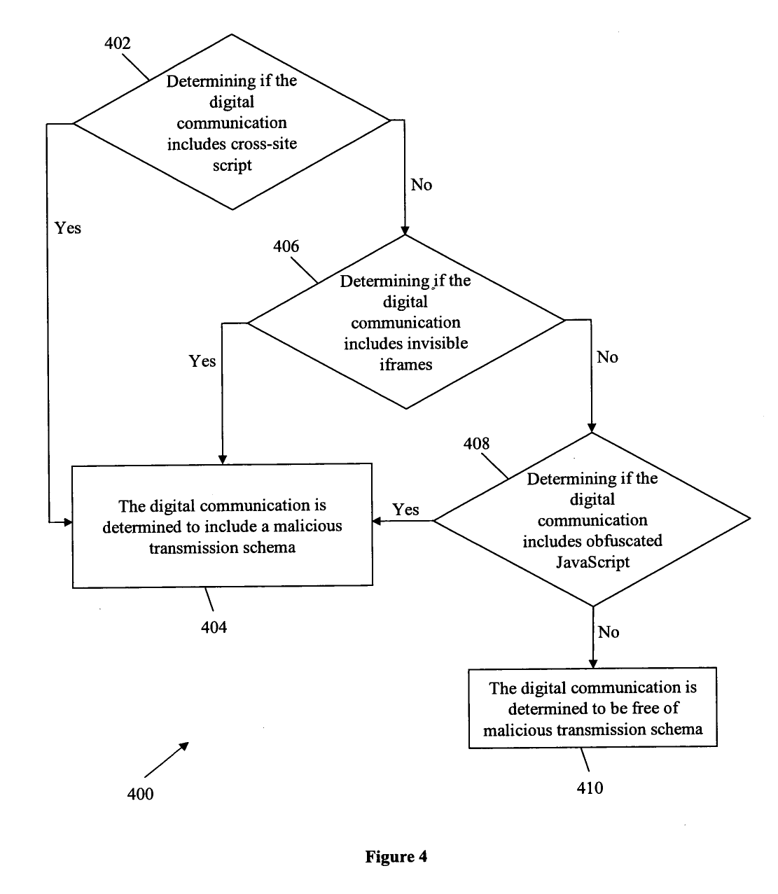

To determine if the digital communication includes a malicious transmission schema, the processor 212 of the network gateway device 204 may check the digital communication to determine if the digital communication includes cross-site script (XSS), invisible iframes, obfuscated JavaScript, phishing iframes, external JavaScript and/or cross-site request forgery. FIG. 4 shows a flowchart 400 of a process for searching a digital communication for a malicious transmission schema. At 402, it is determined if the digital communication includes cross-site script (XSS). If the digital communication includes cross-site script (XSS), the digital communication is determined to include a malicious transmission schema at 404. If the digital communication does not include cross-site script (XSS), the process then proceeds to 406 to determine if the digital communication includes invisible iframes.

If the digital communication includes invisible iframes, the digital communication is determined to include a malicious transmission schema at 404. If the digital communication does not include invisible iframes, the process then proceeds to 408 to determine if the digital communication includes obfuscated JavaScript.

If the digital communication includes obfuscated JavaScript, the digital communication is determined to include a malicious transmission schema at 404. If the digital communication does not include obfuscated JavaScript, the digital communication is determined to be free of malicious transmission schema at 410.

For illustrative purposes, the digital communication is checked for cross-site script (XSS), invisible iframes, and obfuscated JavaScript in the above described process. In some embodiments, the digital communication can also be checked for additional forms of transmission schema in a similar manner, including, for example, phishing iframes, external JavaScript, cross-site request forgery, and/or other forms of malicious transmission schema. The items being checked may vary in different embodiments. From the above described process, the digital communication is checked in an order of detection of cross-site script (XSS), invisible iframes, and obfuscated JavaScript. The order may be decided in such a way to maximize the performance. In different embodiments, the order may vary according to hardware specification and nature of actual traffic for a better performance.

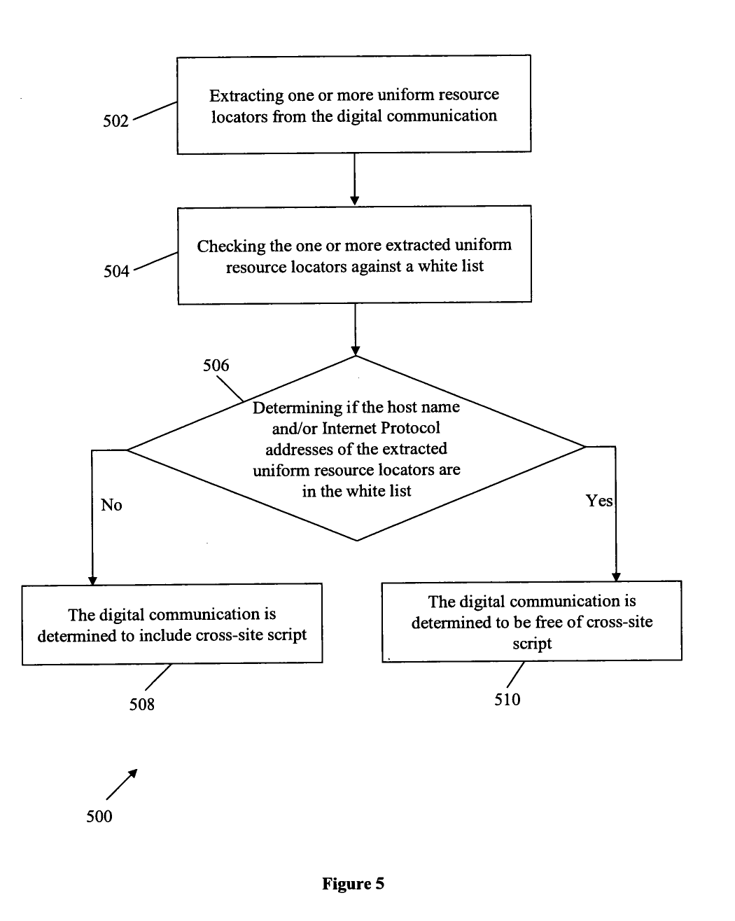

FIG. 5 shows a flowchart 500 of a process for determining if the digital communication includes cross-site script (XSS). At 502, one or more uniform resource locators (URLs) are extracted from the digital communication. At 504, the one or more extracted uniform resource locators (URLs) are checked against a list, for example a configurable white list. At 506, it is determined if at least one of a host name and an Internet Protocol (IP) address of the one or more extracted uniform resource locators (URLs) are in the white list. If the host name and/or the Internet Protocol (IP) address of the extracted uniform resource locators (URLs) are in the white list, it is determined that the digital communication is free of cross-site script (XSS) at 510. If the host name and the Internet Protocol (IP) address of the one or more extracted uniform resource locators (URLs) are not found in the white list, it is determined that the digital communication includes cross-site script (XSS) at 508. Similar techniques can be used with a black list of known malign host names and/or IP addresses instead of a white list of known safe host names and/or IP addresses.

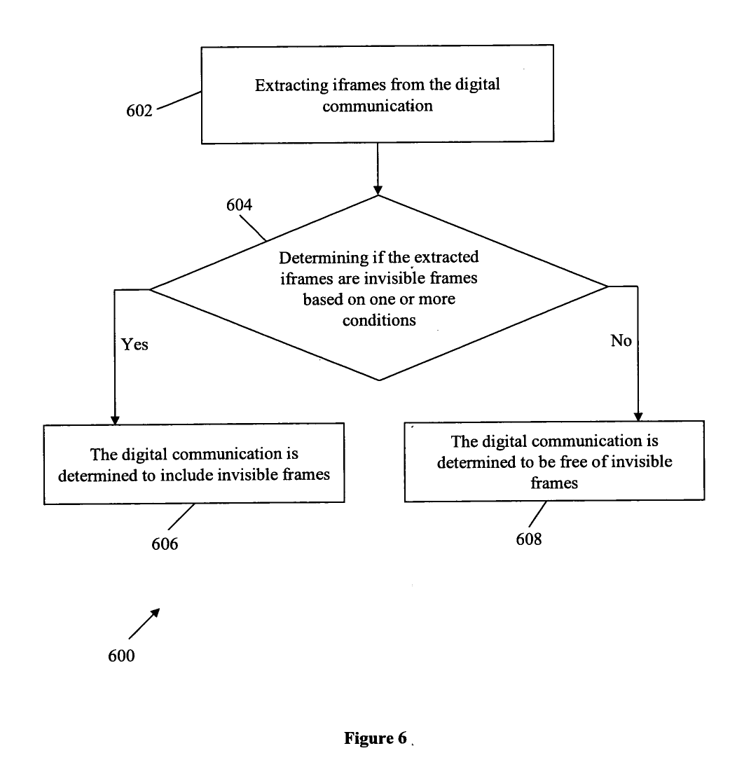

FIG. 6 shows a flowchart 600 of a process for determining if the digital communication includes invisible iframes. At 602, iframes are extracted from the digital communication. At 604, it is determined if the extracted iframes are invisible iframes based on one or more conditions. The conditions may include but are not limited to at least one of a height or a width of the extracted iframe is smaller than a predetermined threshold, the extracted iframe is directly set with hidden style, and the extracted iframe is indirectly set with hidden style. If the one or more conditions are fulfilled, it is determined that the digital communication includes invisible iframes at 606. If none of the conditions are fulfilled, it is determined that the digital communication is free of invisible iframes at 608.

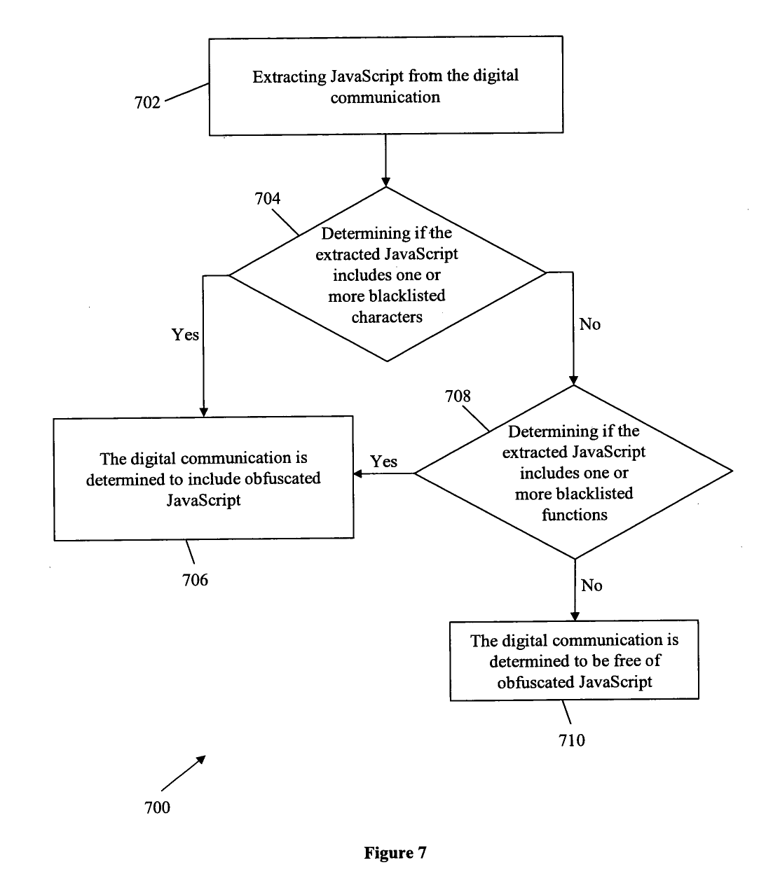

FIG. 7 shows a flowchart 700 of a process for determining if the digital communication includes obfuscated JavaScript. At 702, JavaScript is extracted from the digital communication. At 704, it is determined if the extracted JavaScript includes one or more blacklisted characters. The blacklisted characters may be determined based on a study of JavaScript escape function.

If the extracted JavaScript includes one or more blacklisted characters, it is determined that the digital communication includes obfuscated JavaScript at 706. If the extracted JavaScript does not include blacklisted characters, the process proceeds to 708 to determine if the extracted JavaScript includes one or more blacklisted functions. The blacklisted functions may be predetermined based on a study of rarely used JavaScript functions, and may be configurable according to actual web page design inside the server network. Some examples of the blacklisted functions may be String.fromCharCode, callee.toString, and other functions that are rarely used in normal JavaScript, but can be usually seen in obfuscated JavaScript.

If the extracted JavaScript includes one or more blacklisted functions, it is determined that the digital communication includes obfuscated JavaScript at 706. If the extracted JavaScript does not include blacklisted functions, it is determined that the digital communication is free of obfuscated JavaScript at 710.

Referring to FIG. 2, the processor 212 of the network gateway device 204 may determine if the digital communication includes a malicious transmission schema e.g. in the form of cross-site script (XSS), invisible iframes, obfuscated JavaScript, phishing iframes, external JavaScript and/or cross-site request forgery by carrying out the processes of FIGS. 4 to 7 as described above. If the processor 212 determines that the digital communication includes a malicious transmission schema, the processor 212 may take an action to hinder the transmission of malicious contents. Hindering the transmission of malicious contents can prevent the malicious transmission schema from downloading malicious contents from an external source. Therefore, any possible further spread of malicious contents can be contained.

The processor 212 may send an alert to the recipient of the digital communication. The processor 212 may also send an alert to the server network 202. The processor 212 may block the digital communication. The digital communication may be redirected to a default warning page. The processor 212 may modify the malicious transmission schema found in the digital communication. The malicious transmission schema may be removed from the digital communication. The processor 212 may carry out other possible actions to hinder the transmission of malicious contents in different embodiments.

The processor 212 may carry out one or more of the above described possible actions in different embodiments. For example, the processor 212 may only send an alert to the recipient of the digital communication without blocking the digital communication or without modifying the malicious transmission schema found in the digital communication. Alternatively, the processor 212 may send an alert to the recipient of the digital communication and block the digital communication at the same time. It is also possible for the processor 212 to send an alert to the recipient of the digital communication, send an alert to the server network 202 and modify the malicious transmission schema found in the digital communication at the same time. In short, the processor 212 may carry out different combinations of actions in different embodiments to hinder the transmission of malicious contents.

If the processor 212 determines that the digital communication is free of malicious transmission schema (i.e. if no malicious transmission schema is found), the processor 212 may provide the digital communication to the external network 206. The requested digital communication may be displayed on the requestor machines of the external network 206.

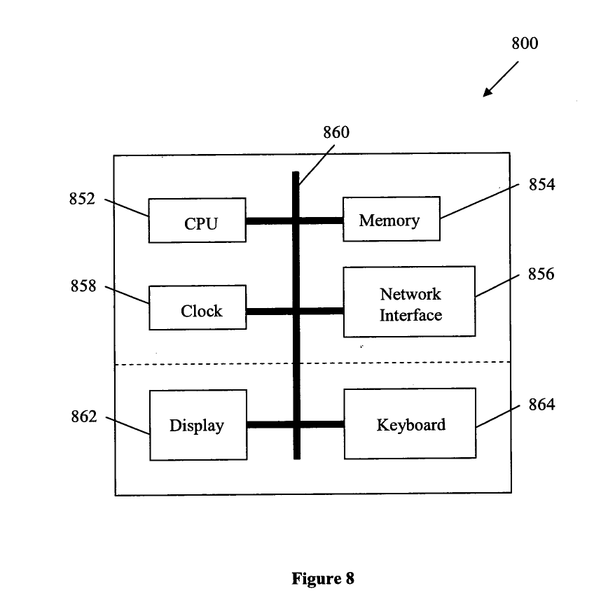

FIG. 8 shows a schematic diagram of a computer system 800. In some embodiments, the network gateway device 204 may be implemented as a computer system similar to the computer system 800. In some embodiments, the network gateway device 204 may also be implemented as modules executing on a computer system similar to the computer system 800.

The computer system 800 may include a CPU 852 (central processing unit), and a memory 854. The memory 854 may be used for storing and/or collecting a list of host names and Internet Protocol addresses, blacklisted characters and blacklisted functions. The memory 854 may include more than one memory, such as Random Access Memory (RAM), Read-Only Memory (ROM), Erasable Programmable Read-Only Memory (EPROM), hard disk, etc. wherein some of the memories are used for storing data and programs and other memories are used as working memories. The computer system 800 may include an input/output (I/O) device such as a network interface 856. The network interface 856 may be used to access an external network e.g. having one or more requestor machines, and a server network e.g. having one or more web servers. The computer system 800 may also include a clock 858, an output device such as a display 862 and an input device such as a keyboard 864. All the components (852, 854, 856, 858, 862, 864) of the computer system 800 are connected and communicating with each other through a bus 860.

In some embodiments, the memory 854 may be configured to store instructions for preventing transmission of malicious contents. The instructions, when executed by the CPU 852, may cause the processor 852 to intercept at a network gateway device of a server network a digital communication being sent from the server network to an external network, to search the digital communication for a malicious transmission schema that can be used to cause a malicious transmission on a recipient of the digital communication and to take an action to hinder the transmission of malicious contents if a malicious transmission schema is found. The processor 852 may send an alert to the recipient of the digital communication if a malicious transmission schema is found. The processor 852 may also send an alert to the server network 202. The processor 852 may block the digital communication if a malicious transmission schema is found. The processor 852 may redirect the digital communication to a default warning page. The processor 852 may modify the malicious transmission schema found in the digital communication. The processor 852 may remove the malicious transmission schema from the digital communication. The processor 852 may provide the digital communication to the external network if no malicious transmission schema is found.

In some embodiments, memory 854 may be configured to store instructions for determining if the digital communication includes cross-site script. The instructions, when executed by the CPU 852, may cause the processor 852 to extract one or more uniform resource locators (URLs) from the digital communication, and to check the one or more extracted uniform resource locators against a list. The processor 852 may determine if at least one of a host name and an Internet Protocol address of the one or more extracted uniform resource locators are in the list.

In some embodiments, memory 854 may be configured to store instructions for determining if the digital communication includes invisible iframes. The instructions, when executed by the CPU 852, may cause the processor 852 to extract iframes from the digital communication, and to determine if the extracted iframes are invisible iframes based on one or more conditions. The one or more conditions may include but are not limited to at least one of a height or a width of the extracted iframe is smaller than a predetermined threshold, the extracted iframe is directly set with hidden style, and the extracted iframe is indirectly set with hidden style.

In some embodiments, memory 854 may be configured to store instructions for determining if the digital communication includes obfuscated JavaScript. The instructions, when executed by the CPU 852, may cause the processor 852 to extract JavaScript from the digital communication, and to determine if the extracted JavaScript comprises at least one of one or more blacklisted characters and one or more blacklisted functions.

In one embodiment, the network gateway device 204 of the server network 202 may operate in different operation modes, for example two operation modes namely prevention mode and detection mode.

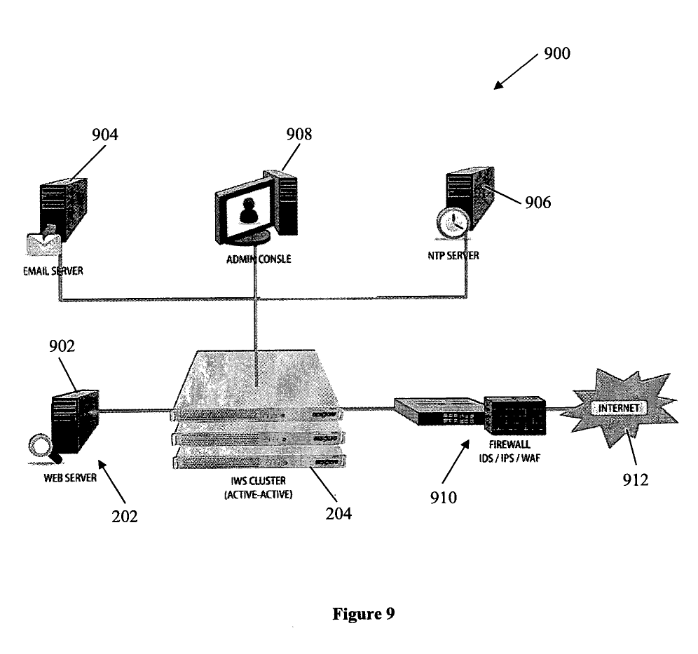

FIG. 9 shows a schematic diagram of a system 900 having one or more network gateway devices 204 operating in prevention mode. In the system 900, the one or more network gateway devices 204 may be coupled to a server network 202 having one or more web servers 902. The one or more network gateway devices 204 may also be coupled to an email server 904, a network time protocol (NTP) server 906 and an administration console 908. The administration console 908 may be coupled to the email server 904 and the network time protocol (NTP) server 906. In one embodiment, the administration console 908 of the system 900 may approve authorized URLs to avoid any unintentional blocking of links to foreign URLs (e.g. links to advertisements or web statistics services) which are required for normal functioning of web sites.

The one or more network gateway devices 204 may be further coupled to an existing firewall 910. The one or more network gateway devices 204 may work together with the existing firewall 910 for preventing transmission of malicious contents. The existing firewall 910 may include but are not limited to intrusion detection system (IDS), intrusion prevention system (IPS) and web applications firewall (WAF). The existing firewall 910 may be coupled to the Internet 912. In some embodiments, the functions of the firewall 910 and the network gateway devices 204 may be combined into a single device.

In the prevention mode, the one or more network gateway devices 204 may take an action to hinder the transmission of malicious contents if a malicious transmission schema is found. The one or more network gateway devices 204 may send an alert to the recipient of the digital communication if a malicious transmission schema is found. The one or more network gateway devices 204 may also send an alert to the server network 202. The one or more network gateway devices 204 may also send an alert to the administration console 908. The one or more network gateway devices 204 may block the digital communication if a malicious transmission schema is found. The one or more network gateway devices 204 may redirect the digital communication to a default warning page. The one or more network gateway devices 204 may modify the malicious transmission schema found in the digital communication. The one or more network gateway devices 204 may remove the malicious transmission schema from the digital communication. The one or more network gateway devices 204 may provide the digital communication to the external network (e.g. the recipient of the digital communication) if no malicious transmission schema is found.

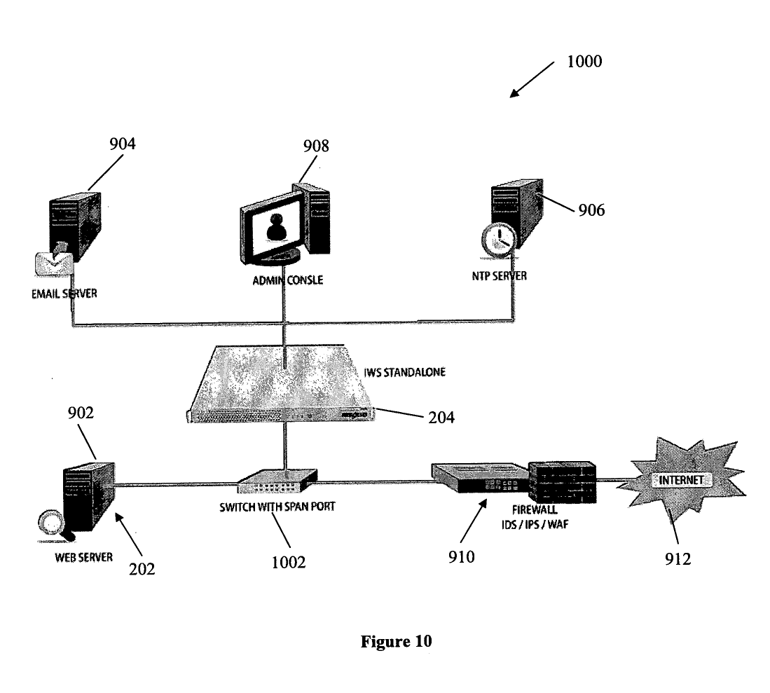

FIG. 10 shows a schematic diagram of a system 1000 having a network gateway device 204 operating in detection mode. In the system 1000, the one or more network gateway device 204 may be coupled to a switch with a span port 1002. The switch with the span port 1002 may be coupled to a server network 202 having one or more web servers 902. The switch with the span port 1002 may be coupled to an existing firewall 910. The existing firewall 910 may include but are not limited to intrusion detection system (IDS), intrusion prevention system (IPS) and web applications firewall (WAF). The existing firewall 910 may be coupled to the Internet 912. In some embodiments, the functions of the network gateway device 204 and the firewall 910 may be combined into a single device.

The network gateway device 204 may also be coupled to an email server 904, a network time protocol (NTP) server 906 and an administration console 908. The administration console 908 may be coupled to the email server 904 and the network time protocol (NTP) server 906. In one embodiment, the administration console 908 of the system 900 may approve authorized URLs to avoid any unintentional blocking of links to foreign URLs (e.g. links to advertisements or web statistics services) which are required for normal functioning of web sites.

In the detection mode, the network gateway device 204 may send an alert to the recipient of the digital communication if a malicious transmission schema is found. The one or more network gateway devices 204 may also send an alert to the server network 202. The one or more network gateway devices 204 may also send an alert to the administration console 908. However, in the detection mode, the network gateway device 204 may not block the digital communication. The digital communication may still be provided to the external network (e.g. the recipient of the digital communication).

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for preventing transmission of malicious contents, the method comprising:
intercepting at a network gateway device of a server network a digital communication being sent from the server network to an external network;
searching the digital communication for a malicious transmission schema that can be used to cause a malicious transmission on a recipient of the digital communication on the external network; and
taking an action to hinder the transmission of malicious contents if a malicious transmission schema is found.

2. The method of claim 1, wherein the malicious transmission is transmitted from a source outside the server network.

3. The method of claim 1, wherein the digital communication comprises one or more of a group consisting of web pages, emails and instant messages.

4. The method of any claim 1, wherein the malicious transmission schema is injected into the digital communication in a form of one or more of a group consisting of cross-site script, invisible iframes, obfuscated JavaScript, phishing iframes, external JavaScript and cross-site request forgery.

5. The method of claim 1, wherein searching the digital communication for a malicious transmission schema comprises one or more of a group consisting of:
determining if the digital communication comprises cross-site script;
determining if the digital communication comprises invisible iframes;
determining if the digital communication comprises obfuscated JavaScript;
determining if the digital communication comprises phishing iframes;
determining if the digital communication comprises external JavaScript;
determining if the digital communication comprises cross-site request forgery.

6. The method of claim 5, wherein determining if the digital communication comprises cross-site script comprises:
extracting one or more uniform resource locators from the digital communication; and
checking the one or more extracted uniform resource locators against a list.

7. The method of claim 6, wherein checking the one or more extracted uniform resource locators against the list comprises determining if at least one of a host name and an Internet Protocol address of the one or more extracted uniform resource locators is in the list.

8. The method of claim 5, wherein determining if the digital communication comprises invisible iframes comprises:
extracting iframes from the digital communication; and
determining if the extracted iframes are invisible iframes based on one or more conditions.

9. The method of claim 8, wherein the one or more conditions comprises one or more of a group consisting of:
at least one of a height or a width of the extracted iframe is smaller than a predetermined threshold;
the extracted iframe is directly set with hidden style; and
the extracted iframe is indirectly set with hidden style.

10. The method of claim 5, wherein determining if the digital communication comprises obfuscated JavaScript comprises:
extracting JavaScript from the digital communication; and
determining if the extracted JavaScript comprises at least one of one or more blacklisted characters and one or more blacklisted functions.

11. The method of claim 1, wherein taking an action to hinder the transmission of malicious contents comprises sending an alert to at least one of the recipient of the digital communication and the server network.

12. The method of claim 1, wherein taking an action to hinder the transmission of malicious contents comprises blocking the digital communication.

13. The method of claim 12, wherein blocking the digital communication comprises redirecting the digital communication to a default warning page.

14. The method of claim 1, wherein taking an action to hinder the transmission of malicious contents comprises modifying the malicious transmission schema found in the digital communication.

15. The method of claim 14, wherein modifying the malicious transmission schema comprises removing the malicious transmission schema from the digital communication.

16. The method of claim 1, further comprising providing the digital communication to the external network if no malicious transmission schema is found.

17. A system for preventing transmission of malicious contents, the system comprising:
a network gateway device of a server network that intercepts a digital communication being sent from the server network to an external network, the network gateway device comprising:
a network connection to the server network and the external network;
a processor configured to:
search the digital communication for a malicious transmission schema that can be used to cause a malicious transmission on a recipient of the digital communication on the external network; and
take an action to hinder the transmission of malicious contents if a malicious transmission schema is found.

18. The system of claim 17, wherein the server network comprises one or more web servers.

19. The system of claim 17, wherein the external network comprises one or more requestor machines.

20. The system of claim 17, wherein the digital communication comprises one or more of a group consisting of web pages, emails and instant messages.

21. The system of claim 17, wherein the malicious transmission schema is injected into the digital communication in a form of one or more of a group consisting of cross-site script, invisible iframes, obfuscated JavaScript, phishing iframes, external JavaScript and cross-site request forgery.

22. The system of claim 21, wherein the processor is configured to determine if the digital communication comprises cross-site script; and
wherein the processor is configured to:
extract one or more uniform resource locators (URLs) from the digital communication; and
check the one or more extracted uniform resource locators against a list.

23. The system of claim 22, wherein the processor is configured to determine if at least one of a host name and an Internet Protocol address of the one or more extracted uniform resource locators is in the list.

24. The system of claim 21, wherein the processor is configured to determine if the digital communication comprises invisible iframes; and
wherein the processor is configured to:
extract iframes from the digital communication; and
determine if the extracted iframes are invisible iframes based on one or more conditions.

25. The system of claim 24, wherein the one or more conditions comprises one or more of a group consisting of:
at least one of a height or a width of the extracted iframe is smaller than a predetermined threshold;
the extracted iframe is directly set with hidden style; and
the extracted iframe is indirectly set with hidden style.

26. The system of claim 21, wherein the processor is configured to determine if the digital communication comprises obfuscated JavaScript; and
wherein the processor is configured to:
extract JavaScript from the digital communication; and
determine if the extracted JavaScript comprises at least one of one or more blacklisted characters and one or more blacklisted functions.

27. The system of claim 17, wherein the processor is configured to send an alert to at least one of the recipient of the digital communication and the server network if a malicious transmission schema is found.

28. The system of claim 17, wherein the processor is configured to block the digital communication if a malicious transmission schema is found.

29. The system of claim 28, wherein the processor is configured to redirect the digital communication to a default warning page.

30. The system of claim 17, wherein the processor is configured to modify the malicious transmission schema found in the digital communication.

31. The system of claim 30, wherein the processor is configured to remove the malicious transmission schema from the digital communication.

32. The system of claim 17, wherein the processor is configured to provide the digital communication to the external network if no malicious transmission schema is found.
